(19) United States
(12) Patent Application Publication
(10) Pub. No.: US 2020/0109751 A1
(43) Pub. Date: Apr. 9, 2020

(54) DISC BRAKE

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 16/591,690

(22) Filed: Oct. 3, 2019

(30) Foreign Application Priority Data
Oct. 4, 2018 (JP) 2018-189270

(51) Int. Cl. F16D 55/2265; B60T 1/06; F16D 65/00; F16D 65/18

(52) U.S. Cl. CPC F16D 55/2265; B60T 1/065; F16D 2121/04; F16D 65/183; F16D 65/0056

(57) ABSTRACT

A disc brake of a floating type includes: an inner pad and an outer pad respectively located on opposite sides of a rotor; a pressing device that presses the inner pad and the outer pad against the rotor; and a housing mounted on a non-rotating member and holding the pressing device. The pressing device includes: first pressing members movable toward the rotor, and at least one second pressing member movable away from the rotor; and a frame held on the housing so as to be movable relative to the housing in an axial direction that is a direction parallel with a rotation axis of the rotor. The frame moves in response to movement of the at least one second pressing member to press the outer pad against the rotor.

### CROSS REFERENCE TO RELATED APPLICATION

The present application claims priority from Japanese Patent Application No. 2018-189270, which was filed on Oct. 4, 2018, the disclosure of which is herein incorporated by reference in its entirety.

### BACKGROUND

The following disclosure relates to a disc brake mounted on a wheel of a vehicle.

Patent Document 1 (Japanese Patent Application Publication No. 2017-207104) discloses a floating-type disc brake including: an inner pad and an outer pad respectively located on opposite sides of a rotor rotatable with a wheel; a pressing device configured to press the inner pad and the outer pad against the rotor; and a housing mounted on a non-rotating member and holding the pressing device. The pressing device includes: one first pressing member held by the housing and movable toward the rotor; one second pressing member held by the housing and movable away from the rotor; and a caliper held on the housing so as to be movable in a direction parallel with a rotation axis of the rotor and configured to move in response to movement of the second pressing member to press the outer pad against the rotor. The caliper has such a shape that extends over outer circumferential surfaces of the inner pad and the outer pad.

### SUMMARY

Accordingly, an aspect of the disclosure relates to improvement of a disc brake including a first pressing member and a second pressing member and to a technique for outputting a large braking force.

In one aspect of the disclosure, a disc brake includes a plurality of first pressing members. Each of the first pressing members presses an inner pad against a rotor, thereby increasing the contact area between the inner pad and the rotor and leading to a uniform surface pressure. This configuration increases a frictional force to be applied to between the rotor and each of the inner pad and the outer pad, resulting in a larger braking force to be applied to a wheel.

### BRIEF DESCRIPTION OF THE DRAWINGS

The objects, features, advantages, and technical and industrial significance of the present disclosure will be better understood by reading the following detailed description of the embodiment, when considered in connection with the accompanying drawings, in which:

FIG. 1 is a perspective view of a disc brake according to a first embodiment;

FIG. 2 is a cross-sectional view taken along line II-II in FIG. 8;

FIG. 3 is a cross-sectional view taken along line III-III in FIG. 8;

FIG. 4 is a cross-sectional view taken along line IV-IV in FIG. 8;

FIG. 5 is a plan view of the disc brake;

FIG. 6 is a perspective view of a frame that is a constituent element of the disc brake;

FIG. 7 is a cross-sectional view of a disc brake in a direction orthogonal to an axis;

FIG. 8 is a front elevational view of the disc brake;

FIG. 9 is a view conceptually illustrating operations of the disc brake; and

FIG. 10 is a view (side view) conceptually illustrating operations of the disc brake.

### EMBODIMENT

Hereinafter, there will be described a disc brake provided for a wheel of a vehicle according to one embodiment by reference to the drawings.

### First Embodiment

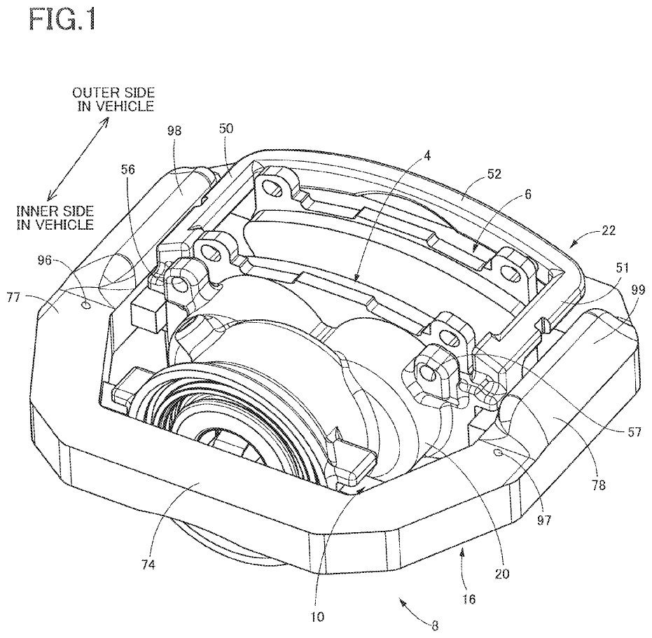

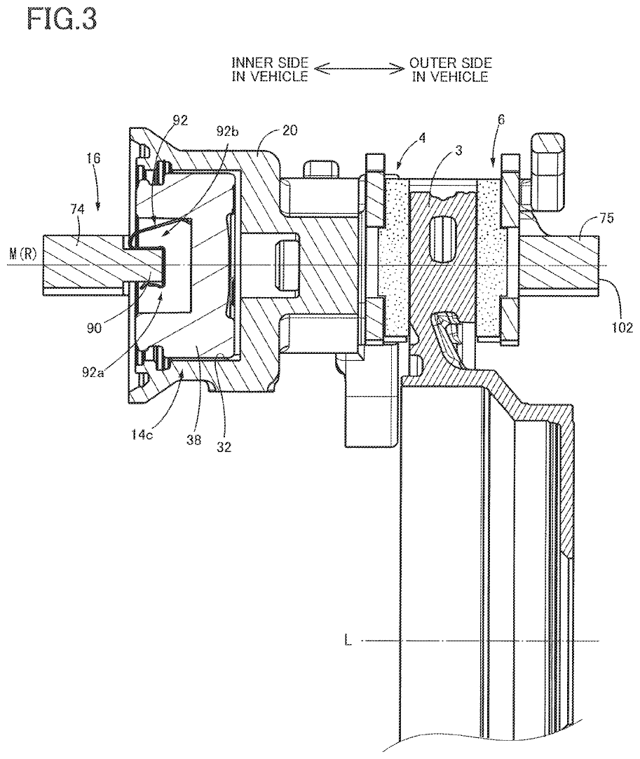

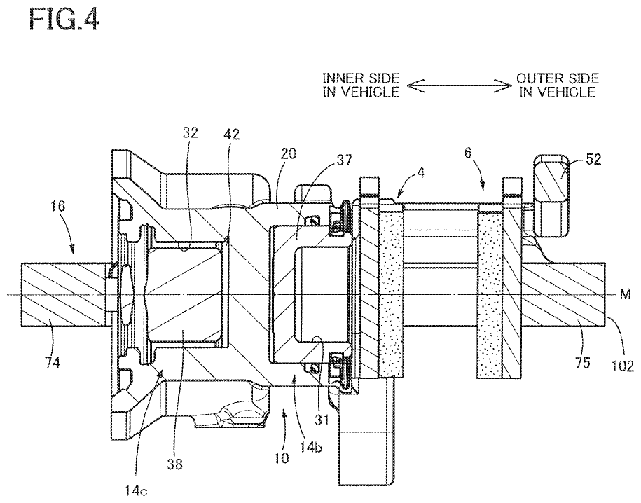

A disc brake according to the present embodiment is a floating disc brake operable by a hydraulic pressure. As illustrated in FIGS. 1-4, the disc brake includes: a rotor 3 that is rotated together with a wheel; an inner pad 4 and an outer pad 6 located on opposite sides of the rotor 3; a pressing device 8; and a housing 10 holding the pressing device 8. The pressing device 8 includes a plurality of first wheel cylinders 14a, 14b and a frame 16. As illustrated in FIG. 3, the rotation axis L of the rotor 3 and the central axis M of the pressing device 8 are parallel with each other. Thus, each of the direction parallel with the rotation axis L of the rotor 3 and the direction parallel with the central axis M of the pressing device 8 may be hereinafter referred to simply as “axial direction”. A side on which the outer pad 6 is located in the axial direction is an outer side in the vehicle, and a side on which the inner pad 4 is located in the axial direction is an inner side in the vehicle. The outer side in the vehicle and the inner side in the vehicle may be hereinafter referred to simply as “outer side” and “inner side”, respectively.

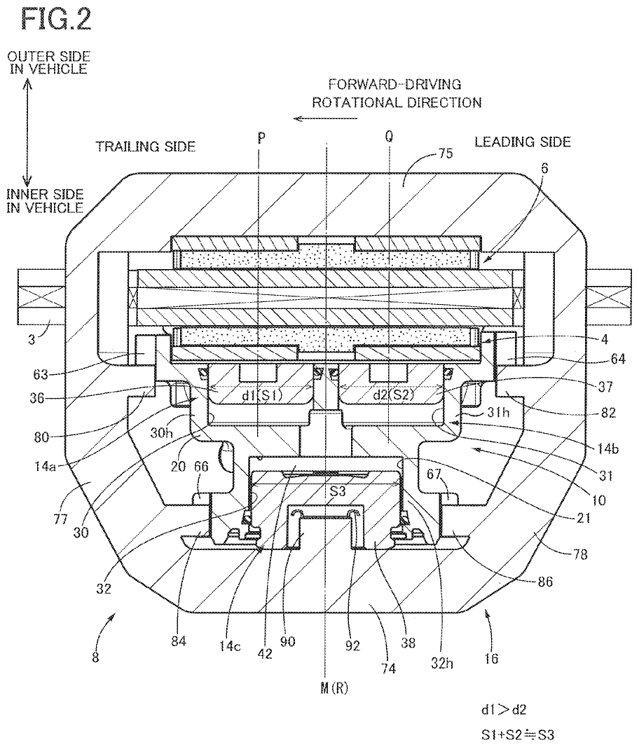

As illustrated in FIG. 5, the housing 10 includes: a main housing portion 20 located on the inner side of the rotor 3; a bridge portion 22 extending from the main housing portion 20 toward the outer side over the rotor 3; and a pair of pad pins 23, 24 spaced apart from each other in the circumferential direction of the rotor 3 (which may be hereinafter referred to simply as “the circumferential direction”). The main housing portion 20 extends substantially in the axial direction. As illustrated in FIG. 2, a through hole 21 is formed through the main housing portion 20 in the axial direction. The through hole 21 includes: first cylinder bores 30, 31 as two first hole portions opening at positions located nearer to the rotor 3; and a second cylinder bore 32 as one second hole portion opening at a position farther from the rotor 3. The center lines P, Q of the respective first cylinder bores 30, 31 are spaced apart from each other in the circumferential direction. The first cylinder bores 30, 31 are located on opposite sides of the central axis M. A first piston 36 as one example of a first pressing member is fluid-tightly and slidably fitted in the first cylinder bore 30 via a piston seat A first piston 37 as another example of the first pressing member is fluid-tightly and slidably fitted in the first cylinder bore 31 via a piston seal. The second cylinder bore 32 is formed at a position at which the central axis R of the second cylinder bore 32 and the central axis M of the pressing device 8 (the main housing portion 20) coincides with each other in plan view. A second piston 38 as one example of a second pressing member is fluid-tightly and slidably fitted in the second cylinder bore 32 via a piston seal. Each of the first cylinder bores 30, 31, and the second cylinder bore 32 communicate with each other. A hydraulic-pressure chamber 42 is formed in the through hole 21 at a position between (i) the first pistons 36, 37 and (ii) the second piston 38. Each of the first pistons 36, 37 and the second piston 38 has a hollow cylindrical shape having a closed bottom. The first pistons 36, 37 and the second piston 38 are provided in a state in which pressure receiving surfaces as bottom portions of the first pistons 36, 37 and the second piston 38 are opposed to the hydraulic-pressure chamber 42.

In the present embodiment, as illustrated in FIG. 2, a portion of the main housing portion 20 at which the first cylinder bore 30 is formed serves as a first cylinder body 30h, and a portion of the main housing portion 20 at which the first cylinder bore 31 is formed serves as a first cylinder body 31h. The first wheel cylinder 14a is constituted by the first cylinder body 30h, the first piston 36, and so on. A first wheel cylinder 14b is constituted by the first cylinder body 31h, the first piston 37, and so on. A portion of the main housing portion 20 at which the second cylinder bore 32 is formed serves as a second cylinder body 32h. A second wheel cylinder 14c is constituted by the second cylinder body 32h, the second piston 38, and so on. The hydraulic-pressure chamber 42 is shared among the first wheel cylinders 14a, 14b and the second wheel cylinder 14c. It is also possible to consider that the main housing portion 20 or a portion of the main housing portion 20 at which the through hole 21 is formed serves as a cylinder body, and one wheel cylinder is constituted by the cylinder body, the first pistons 36, 37, the second piston 38, and so on.

In the present embodiment, the first cylinder bore 31 and the first cylinder bore 30 are located respectively on a leading side and a trailing side in the rotational direction of the rotor 3 during forward driving of the vehicle (which is referred to as “forward-driving rotational direction in FIG. 2”). The inside diameter d2 of the first cylinder bore 31 is less than the inside diameter d1 of the first cylinder bore 30 (d2<d1). The outside diameter d2 of the first piston 37 is less than the outside diameter d1 of the first piston 36. That is, the pressure receiving area S2 that is the area of the pressure receiving surface of the first piston 37 which is opposed to the hydraulic-pressure chamber 42 is less than the pressure receiving area S1 that is the area of the pressure receiving surface of the first piston 36 which is opposed to the hydraulic-pressure chamber 42 (S2<S1).

The cross-sectional area S3 of the second cylinder bore 32 in cross section orthogonal to the central axis M is substantially equal to the sum (S1+S2) of the cross-sectional areas S1, S2 of the respective first cylinder bores 30, 31 in cross section orthogonal to the central axis M. The area S3 of the pressure receiving surface of the second piston 38 which is opposed to the hydraulic-pressure chamber 42 is substantially equal to the sum (S1+S2) of the areas S1, S2 of the pressure receiving surfaces of the respective first pistons 36, 37 which are opposed to the hydraulic-pressure chamber 42 (S1+S2≈S3). Thus, the hydraulic pressure in the hydraulic-pressure chamber 42 makes a pressing force to be applied to the second piston 38 and the sum of pressing forces to be applied to the respective first pistons 36, 37 substantially equal to each other. That is, a pressing force applied to the inner pad 4 in the axial direction and a pressing force applied to the outer pad 6 in the axial direction are substantially equal to each other.

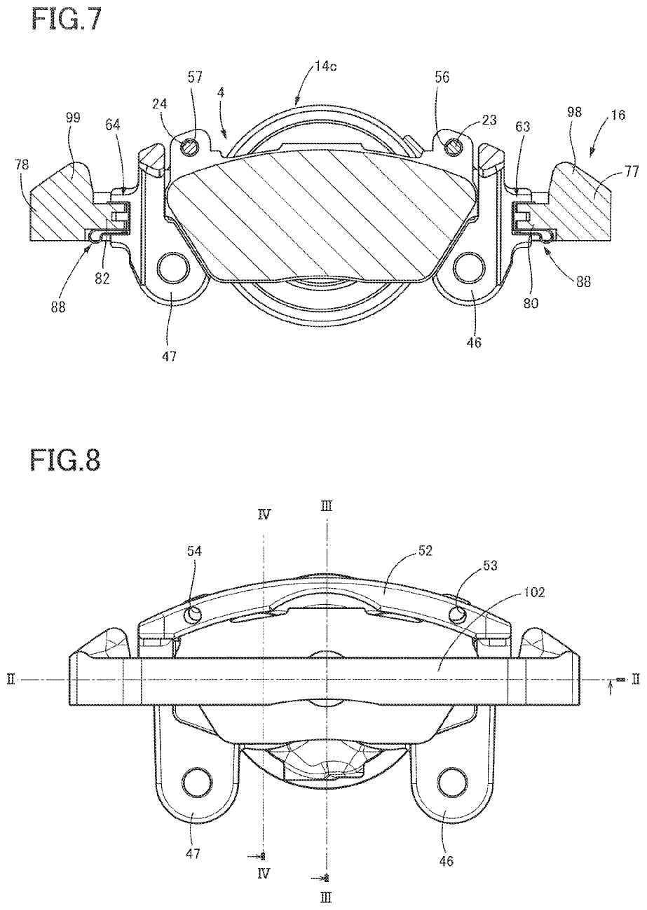

As illustrated in FIGS. 7 and 8, a pair of mount portions 46, 47 are provided on opposite sides, in the circumferential direction, of a rotor-side end portion of the main housing portion 20 in the axial direction. Each of the mount portions 46, 47 is secured to a corresponding one of suspension members (which may be also referred to as “vehicle-body-side component”) such as a knuckle as one example of a non-rotating member.

As illustrated in FIGS. 1 and 5, the bridge portion 22 has a substantially three-sided rectangular shape in plan view. The bridge portion 22 includes: a pair of rods 50, 51 spaced apart from each other in the circumferential direction and each extending in the axial direction; and a coupler 52 coupling the rods 50, 51 to each other. As illustrated in FIGS. 7 and 8, the coupler 52 has two through holes 53, 54 spaced apart from each other in the circumferential direction. Through holes 56, 57 are respectively formed in portions of the main housing portion 20 which correspond to the respective through holes 53, 54. The pad pin 23 is fit in the through holes 53, 56, and the pad pin 24 is fit in the through holes 54, 57 in a state in which the pad pins 23, 24 extend in the axial direction. Each of the pad pins 23, 24 extends through a corresponding one of the through holes 56, 57, the inner pad 4, the outer pad 6, and a corresponding one of the through holes 53, 54 in this order. Thus, the inner pad 4 and the outer pad 6 are held by the pad pins 23, 24 so as to be movable in the axial direction. It is noted that pad springs, not illustrated, are attached to the pad pins 23, 24 to reduce looseness, and so on of the inner pad 4 and the outer pad 6, resulting in reduced vibrations and abnormal sounds.

Two pairs of engageable recessed portions engageable with the frame 16 are provided on the main housing portion 20 so as to be spaced apart from each other in the axial direction. As illustrated in FIGS. 2 and 7, the two pairs of engageable recessed portions include a pair of first engageable recessed portions 63, 64 and a pair of second engageable recessed portions 66, 67. The first engageable recessed portions 63, 64 are provided at the rotor-side end portion of the main housing portion 20. The second engageable recessed portions 66, 67 are provided at an end portion of the main housing portion 20 which is far from the rotor 3. The first engageable recessed portions 63, 64 are spaced apart from each other in the circumferential direction. The second engageable recessed portions 66, 67 are spaced apart from each other in the circumferential direction. In the present embodiment, the first engageable recessed portion 63 and the second engageable recessed portion 66, and the first engageable recessed portion 64 and the second engageable recessed portion 67 are symmetric with respect to the central axis M. That is, the first and second engageable recessed portions 63, 66 and the first and second engageable recessed portions 64, 67 are symmetric in shape with respect to the central axis M and are provided respectively at positions that are symmetric with respect to the central axis M. Each of the first engageable recessed portions 63, 64 and the second engageable recessed portions 66, 67 may be a grooved portion extending in the axial direction and recessed in the circumferential direction.

As illustrated in FIGS. 1, 2, 5, and 6, the frame 16 is a rigid member having a substantially frame shape and held by the main housing portion 20 so as to be movable relative to each other in the axial direction. The frame 16 includes: a first side portion 74 and a second side portion 75 extending in the direction orthogonal to the central axis M and spaced apart from each other in the axial direction; and a third side portion 77 and a fourth side portion 78 extending in the direction intersecting the first side portion 74 and the second side portion 75 and spaced apart from each other in the circumferential direction. The third side portion 77 and the fourth side portion 78 couple the first side portion 74 and the second side portion 75 to each other. The first side portion 74 and the second side portion 75 are located on opposite sides of the rotor 3 in the axial direction. The first side portion 74 is located on the inner side of the rotor 3 and opposed to the second piston 38. The second side portion 75 is located on an outer side of the rotor 3 and engaged with the outer pad 6 so as to be movable together with the outer pad 6 in the axial direction.

Each of the third side portion 77 and the fourth side portion 78 extends toward the outer and inner sides of the rotor 3. Specifically, as illustrated in FIGS. 1, 2, and 5, each of the third side portion 77 and the fourth side portion 78 extends over the rotor 3 without extending over outer circumferential surfaces of the inner pad 4 and the outer pad 6 in the radial direction.

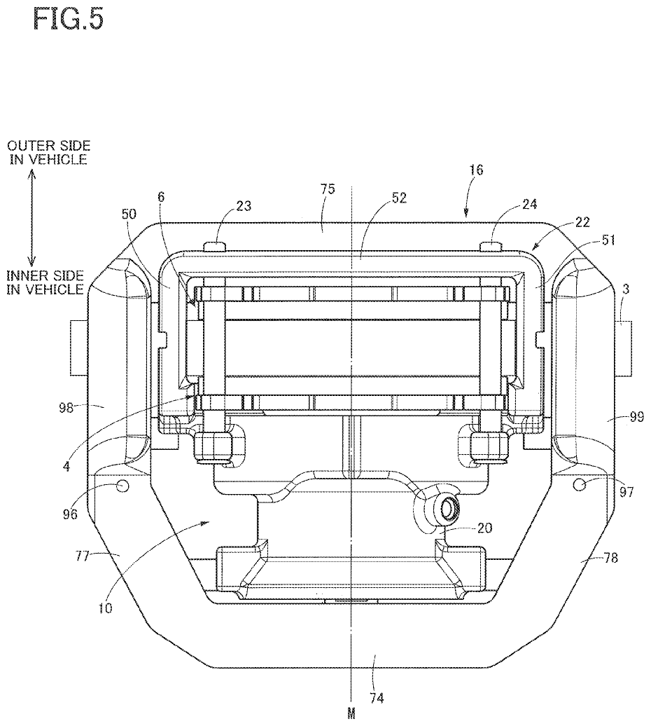

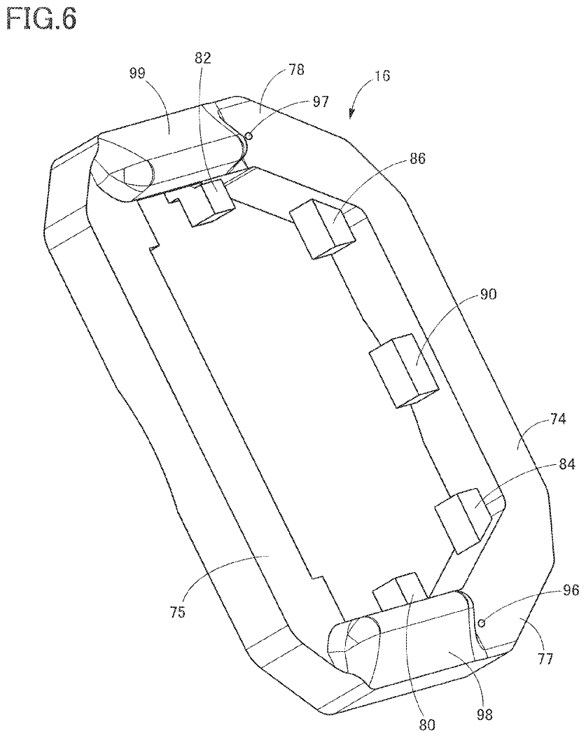

As illustrated in FIG. 6, two pairs of engageable protrusions are provided on inner surfaces of the third side portion 77 and the fourth side portion 78 which face each other at positions located on the inner side of the rotor 3. The two pairs of engageable protrusions are spaced apart from each other in the axial direction. A pair of first engageable protrusions 80, 82 of the two pairs of engageable protrusions are located nearer to the rotor 3 than a pair of second engageable protrusions 84, 86 of the two pairs of engageable protrusions. In the present embodiment, the first engageable protrusions 80 and the second engageable protrusion 84, and the first engageable protrusions 82 and the second engageable protrusion 86 are symmetric with respect to the central axis M. That is, the first engageable protrusion 80 and the second engageable protrusion 84, and the first engageable protrusion 82 and the second engageable protrusion 86 are symmetric in shape with respect to the central axis M and are provided on the frame 16 at symmetric positions.

The first engageable protrusions 80, 82 are engaged with the respective first engageable recessed portions 63, 64, and the second engageable protrusions 84, 86 are engaged with the respective second engageable recessed portions 66, 67, whereby the frame 16 is held by the housing 10 so as to be movable in the axial direction. As illustrated in FIG. 7, leaf springs in the form of springs 88 may be respectively provided between the first engageable protrusions 80, 82 and the first engageable recessed portions 63, 64 and between the second engageable protrusions 84, 86 and the second engageable recessed portions 66, 67. For example, in the case where the corrosion potential of each of the springs is a middle amount between the corrosion potential of the frame 16 and the corrosion potential of the housing 10, the potential difference between the sliding-contact members can be made small, resulting in reduced corrosion of the housing 10, for example, when compared with the case where the frame 16 and the housing 10 are brought into direct sliding contact with each other. The springs reduce positional misalignment of the frame 16 relative to the main housing portion 20 in the radial direction and the circumferential direction, resulting in reduced vibrations and abnormal sounds.

An engageable protrusion 90 is provided on a central portion of the first side portion 74 of the frame 16. As illustrated in FIG. 3, a resilient member in the form of a coupling spring 92 is attached to the engageable protrusion 90. The coupling spring 92 is a leaf spring which includes: a fitting portion 92a bent into a groove shape in side view; and a curved portion 92b. The coupling spring 92 is fitted at the fitting portion 92a on the engageable protrusion 90 in the radial direction such that a distal end portion of the curved portion 92b is in contact with an inner circumferential surface of a recessed portion of the second piston 38. This configuration enables the second piston 38 and the frame 16 to move together with each other, while the coupling spring 92 positions the frame 16 with respect to the second piston 38.

A pair of machining datums 96, 97 are provided respectively in the third side portion 77 and the fourth side portion 78 of the frame 16 at positions located on the inner side of the rotor 3. Jigs are to be mounted in the respective machining datums 96, 97 when performing working on the frame 16. In the case of manufacturing of the frame 16, coating is usually performed after working such as cutting and polishing. However, the working may be performed after coating, in the case where the working has little effect on coating of a coolant to be used for working. The former case requires an operation such as masking on a region on which coating is not to be performed. The latter case does not require operations such as masking but suffers from a problem that machining datums are left in which jigs are mounted in the case where the jigs are mounted on the frame 16 in working.

To solve this problem, in the present embodiment, the machining datums 96, 97 are provided respectively on the inner side of portions of the third side portion 77 and the fourth side portion 78 of the frame 16 which correspond to the rotor 3. In the present embodiment, rising portions 98, 99 which are larger in thickness than other portions are provided respectively on the portions of the third side portion 77 and the fourth side portion 78 which correspond to the rotor 3. The machining datums 96, 97 are provided at portions located on the inner side of the respective rising portions 98, 99. As a result, it is difficult for the machining datums 96, 97 to be viewed from the outer side of the vehicle (a side on which the outer surface 102 of the second side portion 75 is located), preventing deterioration of the appearance of the disc brake from the outer side.

Each of the machining datums 96, 97 generally has a triangular-pyramid shape or a circular-cone shape. Forces are applied to various positions of the frame 16 from various positions in working. In the present embodiment, in contrast, the jigs make it possible to apply pressing forces to the frame 16 from various directions, enabling the frame 16 to be held well in working.

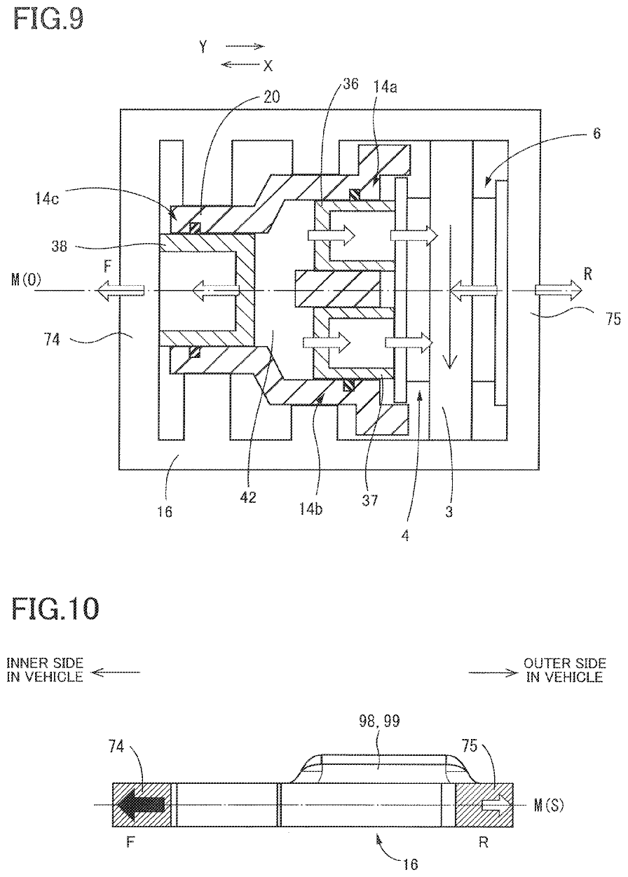

As illustrated in FIG. 9, the disc brake configured as described above is operated by the hydraulic pressure in the hydraulic-pressure chamber 42 defined by the first wheel cylinders 14a, 14b and the second wheel cylinder 14c. A pressing force obtained by multiplying the hydraulic pressure in the hydraulic-pressure chamber 42 by the pressure receiving area of each piston is applied to a corresponding one of the first pistons 36, 37 and the second piston 38. The first pistons 36, 37 are moved in the direction indicated by the arrow Y toward the rotor 3 in the axial direction to press the inner pad 4 against the rotor 3. The second piston 38 is moved in the direction indicated by the arrow X (the direction away from the rotor 3) in the axial direction to move the frame 16 in the direction indicated by the arrow X. The movement of the frame 16 in the direction indicated by the arrow X presses the outer pad 6 against the rotor 3. The rotor 3 is pressed by the inner pad 4 and the outer pad 6 from opposite sides of the rotor 3, whereby the rotor 3 and each of the inner pad 4 and the outer pad 6 are brought into frictional engagement with each other. As a result, the disc brake is operated to reduce rotation of the wheel.

In the present disc brake, the two first pistons 36, 37 are arranged in the circumferential direction. As a result, in the case where each of the inner pad 4 and the outer pad 6 is extended in the circumferential direction to increase the size of the pad, it is possible to increase the contact area between the rotor 3 and each of the inner pad 4 and the outer pad 6, making it possible to apply a large braking force.

In particular, while it is considered that the size of each of the inner pad 4 and the outer pad 6 is increased in a vehicle achieving high power-driven performance and requiring a large braking force, in the case where the number of the first pistons is one, it is difficult to increase the contact area between the rotor 3 and each of the inner pad 4 and the outer pad 6, making it difficult to effectively increase the braking force. In the present embodiment, in contrast, it is possible to increase the contact area between the rotor 3 and each of the inner pad 4 and the outer pad 6, making it possible to apply a large braking force. As a result, the present disclosure is applicable to vehicles that require a large braking force.

In addition, the pressure receiving area of the piston with respect to the hydraulic-pressure chamber 42 is smaller in the first wheel cylinder 14b on the leading side than in the first wheel cylinder 14a on the trailing side. While the vehicle is driving forward, the surface pressure between the rotor 3 and each of the inner pad 4 and the outer pad 6 becomes easily higher at a portion on the leading side than at a portion on the trailing side, by rotation of the pad following rotation of the rotor 3. In the present embodiment, a pressing force to be applied to the piston is smaller in the first wheel cylinder 14b on the leading side than in the first wheel cylinder 14a on the trailing side. This makes it difficult for the surface pressure to become high at a position on the leading side between the rotor 3 and each of the inner pad 4 and the outer pad 6, resulting in uniform surface pressure between the rotor 3 and each of the inner pad 4 and the outer pad 6.

In the disc brake according to the present embodiment as described above, the contact area between the rotor 3 and each of the inner pad 4 and the outer pad 6 is increased to make the surface pressures uniform. When compared with the case where the contact area is small, and the surface pressures are not uniform, the coefficient of friction between the rotor 3 and each of the inner pad 4 and the outer pad 6 is large in a state in which the pressing force is large. This further makes it possible to apply a large braking force to the wheel.

Also, it is possible to make it difficult for the frictional force to become large at the position on the leading side between the rotor 3 and each of the inner pad 4 and the outer pad 6. This reduces partial wear of each of the rotor 3, the inner pad 4, and the outer pad 6.

The sum (S1+S2) of the areas of the pressure receiving surfaces of the first pistons 36, 37 with respect to the hydraulic-pressure chamber 42 is substantially equal to the area S3 of the pressure receiving surface of the second piston 38 with respect to the hydraulic-pressure chamber 42. Thus, a force to be applied to the inner pad 4 in the axial direction and a force to be applied to the outer pad 6 in the axial direction can be made substantially equal to each other.

The frame 16 receives a reaction force R related to the pressing force F applied from the outer pad 6 to the rotor 3. That is, the frame 16 receives the pressing force F and the reaction force R respectively directed in opposite directions. As illustrated in FIG. 10, the lines of application of the forces F, R are located on the same plane in the frame 16. This configuration reduces inclination of the frame 16 during operation of the disc brake, thereby reducing lowering of the pressing force due to the inclination of the frame 16.

In the main housing portion 20, the second cylinder bore 32 is provided at a position at which the center line R of the second cylinder bore 32 substantially coincides with the central axis M of the pressing device 8. If the timings of movement of a plurality of second pistons have been shifted from each other, for example, in the case where a plurality of the second wheel cylinders are arranged in the circumferential direction, there is a possibility of inclination of the frame 16 when the frame 16 is moved in the X direction. In the present embodiment, in contrast, the one second wheel cylinder 14c is provided so as to be opposed to a central portion of the frame 16 in the circumferential direction, making it possible to well reduce the inclination of the frame 16 during operation of the disc brake.

It is noted that the main housing portion 20 may have three or more first cylinder bores. In this case, the center lines of the respective first cylinder bores are spaced apart from each other at least in the circumferential direction. Providing three or more first cylinder bores further makes the surface pressures uniform and increases the contact area.

In the case where three or more first wheel cylinders are provided, the cross-sectional area of a first wheel cylinder on the most-leading side may be less than that of a first wheel cylinder on a most-trailing side, and the three or more first wheel cylinders may be arranged in decreasing order of the cross-sectional area from the trailing side toward the leading side, for example.

The disc brake is not limited to the hydraulic disc brake and may be an electric disc brake operable by an electric driving force. While the embodiment and modifications have been described above, it is to be understood that the disclosure is not limited to the details of the illustrated embodiment and modifications, but may be embodied with various changes and modifications, which may occur to those skilled in the art, without departing from the spirit and scope of the disclosure.

### Claimable Inventions

(1) A disc brake of a floating type, comprising:

an inner pad and an outer pad respectively located on opposite sides of a rotor rotatable with a wheel;

a pressing device configured to press the inner pad and the outer pad against the rotor; and

a housing mounted on a non-rotating member and holding the pressing device,

wherein the pressing device comprises:
a plurality of first pressing members and at least one second pressing member held on the housing, the plurality of first pressing members being movable toward the rotor, the at least one second pressing member being movable away from the rotor; and
a frame held on the housing so as to be movable relative to the housing in an axial direction that is a direction parallel with a rotation axis of the rotor, the frame being configured to move in response to movement of the at least one second pressing member to press the outer pad against the rotor.

(2) The disc brake according to the above form (1),

wherein the housing comprises a plurality of first hole portions opening in one of opposite portions of the housing which is nearer to the rotor than the other of the opposite portions, and center lines of the plurality of first hole portions are spaced apart from each other in a circumferential direction of the rotor in a state in which each of the plurality of first hole portions extends in the axial direction, and

wherein the plurality of first pressing members are respectively held on the plurality of first hole portions of the housing so as to be movable in the axial direction.

The plurality of first hole portions are formed in the housing respectively at positions at which the center lines of the plurality of first hole portions are at least spaced apart from each other in the circumferential direction of the rotor. For example, the plurality of first hole portions may be formed in the housing respectively at positions at which the respective center lines of the plurality of first hole portions are spaced apart from each other in the circumferential direction and the radial direction of the rotor. The plurality of first hole portions may be formed in the housing and arranged so as to be spaced apart from each other in the circumferential direction of the rotor.

(3) The disc brake according to the above form (2),

wherein the plurality of first hole portions are arranged in decreasing order of inside diameter from a trailing side toward a leading side, and

wherein the plurality of first pressing members are arranged in decreasing order of outside diameter from the trailing side toward the leading side.

(4) The disc brake according to the above form (2) or (3),

wherein an inside diameter of one of the plurality of first hole portions which is located on a most-leading side is less than that of another of the plurality of first hole portions which is located on a most-trailing side, and

wherein an outside diameter of one of the plurality of first pressing members which is located on the most-leading side is less than that of another of the plurality of first pressing members which is located on the most-trailing side.

(5) The disc brake according to any one of the above forms (1) through (4),

wherein the housing comprises at least one second hole portion opening in one of opposite portions of the housing which is farther from the rotor than the other of the opposite portions, in a state in which the at least one second hole portion extends in the axial direction, and

wherein the at least one second pressing member is held on the at least one second hole portion of the housing so as to be movable relative to the at least one second hole portion in the axial direction.

(6) The disc brake according to the above form (5),

wherein one second hole portion as the at least one second hole portion is formed in the housing at a position at which a central axis of the one second hole portion coincides with a central axis of the pressing device in a circumferential direction thereof, and

wherein one second pressing member as the at least one second pressing member is held on the one second hole portion of the housing.

(7) The disc brake according to any one of the above forms (1) through (5),

wherein the housing comprises:
a plurality of first hole portions opening in one of opposite portions of the housing which is nearer to the rotor than the other of the opposite portions, center lines of the plurality of first hole portions being spaced apart from each other in a circumferential direction of the rotor in a state in which each of the plurality of first hole portions extends in the axial direction; and
at least one second hole portion opening in the other of the opposite portions of the housing which is farther from the rotor than the one of the opposite portions, in a state in which the at least one second hole portion extends in the axial direction,

wherein the plurality of first hole portions and the at least one second hole portion communicate with each other, and a hydraulic-pressure chamber is formed at a region at which the plurality of first hole portions and the at least one second hole portion communicate with each other, and

wherein the pressing device comprises at least three wheel cylinders operable by a hydraulic pressure in the hydraulic-pressure chamber.

In the case where the disc brake is a hydraulic disc brake, a hydraulic pressure to be applied to a first piston as the plurality of first pressing members and a hydraulic pressure to be applied to a second piston as the at least one second pressing member are equal in magnitude to each other.

(8) The disc brake according to the above form (7), wherein the at least three wheel cylinders comprise at least two first wheel cylinders, center lines of which are spaced apart from each other in the circumferential direction of the rotor.

In the disc brake according to this form, the first wheel cylinder is constituted by a portion of the housing at which a first cylinder bore as the first hole portion is formed, and a first piston as the first pressing member, for example. A second wheel cylinder is constituted by a portion of the housing at which a second cylinder bore as the second hole portion is formed, and a second piston as the second pressing member, for example. At least two first wheel cylinders are provided so as to be opposed to the inner pad such that the center lines of the respective first wheel cylinders are spaced apart from each other in the circumferential direction of the rotor, and at least one second wheel cylinder is provided so as to be opposed to the frame.

(9) The disc brake according to the above form (7) or (8), wherein the total area of a pressure receiving surface of the at least one second pressing member which faces the hydraulic-pressure chamber is equal to the total area of pressure receiving surfaces of the plurality of first pressing members which face the hydraulic-pressure chamber.

The wording “equal” in the wordings “the total area of a pressure receiving surface of the at least one second pressing member which faces the hydraulic-pressure chamber is equal to the total area of pressure receiving surfaces of the plurality of first pressing members which face the hydraulic-pressure chamber” means “substantially equal” and is not limited to “completely equal”. In the disc brake according to this form, in the case where a hydraulic pressure to be applied to each of the at least one second pressing member and a hydraulic pressure to be applied to each of the plurality of first pressing members are equal in magnitude to each other, a total pressing force to be applied to the at least one second pressing member and a total pressing force to be applied to the plurality of first pressing members are equal to each other. As a result, a pressing force of the inner pad with respect to the rotor and a pressing force of the outer pad with respect to the rotor become equal to each other, making it possible to operate the disc brake well.

(10) The disc brake according to any one of the above forms (1) through (9), wherein a total pressing force to be applied to the plurality of first pressing members is equal to a total pressing force to be applied to the at least one second pressing member.

The wording “equal” in the wordings “a total pressing force to be applied to the plurality of first pressing members is equal to a total pressing force to be applied to the at least one second pressing member” means “substantially equal” and is not limited to “completely equal”.

(11) The disc brake according to any one of the above forms (1) through (10), wherein the frame has a substantially frame shape and comprises:

a first side portion opposed to the second pressing member;

a second side portion engaged with the outer pad so as to be movable together with the outer pad in a direction parallel with the rotation axis of the rotor; and

a third side portion and a fourth side portion coupling the first side portion and the second side portion to each other and spaced apart from each other in a circumferential direction.

The frame is mounted in a state in which each of the third side portion and the fourth side portion does not extend over circumferential surfaces of the inner pad and the outer pad.

(12) The disc brake according to the above form (11), wherein each of the third side portion and the fourth side portion comprises:

a rising portion having a large thickness and located at a position corresponding to the rotor; and

a machining datum provided at a position located on a vehicle-inner side of the rising portion.

Since the machining datum is provided on the inner side of the rising portion, it is difficult to see the machining datum from a vehicle-outer side.

(13) The disc brake according to any one of the above forms (1) through (12), wherein at least a pair of engageable protrusions formed on the frame are engaged respectively with at least a pair of engageable recessed portions formed in the housing to cause the frame to be held by the housing so as to be movable in the axial direction.

What is claimed is:

1. A disc brake of a floating type, comprising:
an inner pad and an outer pad respectively located on opposite sides of a rotor rotatable with a wheel;
a pressing device configured to press the inner pad and the outer pad against the rotor; and
a housing mounted on a non-rotating member and holding the pressing device,
wherein the pressing device comprises:
a plurality of first pressing members and at least one second pressing member held on the housing, the plurality of first pressing members being movable toward the rotor, the at least one second pressing member being movable away from the rotor; and
a frame held on the housing so as to be movable relative to the housing in an axial direction that is a direction parallel with a rotation axis of the rotor, the frame being configured to move in response to movement of the at least one second pressing member to press the outer pad against the rotor.

2. The disc brake according to claim 1,
wherein the housing comprises a plurality of first hole portions opening in one of opposite portions of the housing which is nearer to the rotor than the other of the opposite portions, and center lines of the plurality of first hole portions are spaced apart from each other in a circumferential direction of the rotor in a state in which each of the plurality of first hole portions extends in the axial direction, and
wherein the plurality of first pressing members are respectively held on the plurality of first hole portions of the housing so as to be movable in the axial direction.

3. The disc brake according to claim 2,
wherein the plurality of first hole portions are arranged in decreasing order of inside diameter from a trailing side toward a leading side, and
wherein the plurality of first pressing members are arranged in decreasing order of outside diameter from the trailing side toward the leading side.

4. The disc brake according to claim 2,
wherein an inside diameter of one of the plurality of first hole portions which is located on a most-leading side is less than that of another of the plurality of first hole portions which is located on a most-trailing side, and
wherein an outside diameter of one of the plurality of first pressing members which is located on the most-leading side is less than that of another of the plurality of first pressing members which is located on the most-trailing side.

5. The disc brake according to claim 1,
wherein the housing comprises one second hole portion opening in one of opposite portions of the housing which is farther from the rotor than the other of the opposite portions, in a state in which the one second hole portion extends in the axial direction, and a center line of the one second hole portion coincides with a central axis of the pressing device in a circumferential direction, and
wherein one second pressing member as the at least one second pressing member is held on the one second hole portion of the housing so as to be movable relative to the one second hole portion in the axial direction.

6. The disc brake according to claim 1,
wherein the housing comprises:
a plurality of first hole portions opening in one of opposite portions of the housing which is nearer to the rotor than the other of the opposite portions, center lines of the plurality of first hole portions being spaced apart from each other in a circumferential direction of the rotor in a state in which each of the plurality of first hole portions extends in the axial direction; and
at least one second hole portion opening in the other of the opposite portions of the housing which is farther from the rotor than the one of the opposite portions, in a state in which the at least one second hole portion extends in the axial direction,
wherein the plurality of first hole portions and the at least one second hole portion communicate with each other, and a hydraulic-pressure chamber is formed at a region at which the plurality of first hole portions and the at least one second hole portion communicate with each other, and
wherein the pressing device comprises at least three wheel cylinders operable by a hydraulic pressure in the hydraulic-pressure chamber.

7. The disc brake according to claim 6, wherein the at least three wheel cylinders comprise at least two first wheel cylinders, center lines of which are spaced apart from each other in the circumferential direction of the rotor.

8. The disc brake according to claim 6, wherein the total area of a pressure receiving surface of the at least one second pressing member which faces the hydraulic-pressure chamber is equal to the total area of pressure receiving surfaces of the plurality of first pressing members which face the hydraulic-pressure chamber.

9. The disc brake according to claim 1, wherein a total pressing force to be applied to the plurality of first pressing members is equal to a total pressing force to be applied to the at least one second pressing member.
